(19) United States
(12) Patent Application Publication
(10) Pub. No.: US 2020/0254985 A1
(43) Pub. Date: Aug. 13, 2020

(54) BRAKE PRESSURE SENSOR FOR DETERMINATION OF BRAKING EFFICIENCY

(71) Applicant: The Goodyear Tire & Rubber Company, Akron, OH (US)

(72) Inventors: Guy Wiesen, Stegen (LU); Lassi Mikael Hartikainen, Luxembourg (LU)

(21) Appl. No.: 16/273,506

(22) Filed: Feb. 12, 2019

(51) Int. Cl. B60T 8/171; B60T 8/1761; B60T 17/22

(52) U.S. Cl. CPC B60T 8/171; B60T 2270/88; B60T 17/221; B60T 8/17613

(57) ABSTRACT

A brake pressure sensor for determination of braking efficiency includes a body that in turn includes a first half and a second half. The first half of the body includes a semi-circular recess formed on an inner surface, and the second half of the body includes a semi-circular recess formed on an inner surface. A circular opening is formed by alignment of the first body half recess with the second body half recess. The body engages an exterior of a hose of a brake unit of an anti-lock braking system by receiving the hose in the circular opening, and a strain gauge is attached to an outer surface of the first half of the body. As the anti-lock braking system is actuated and a pressure inside the hose increases, a diameter of the hose increases, creating increased strain in the body that is measured by the strain gauge.

### FIELD OF THE INVENTION

The invention relates to the design of tires. More particularly, the invention relates to the determination of braking efficiency of an anti-lock braking system for a vehicle that is equipped with tires. Specifically, the invention is directed to a sensor for measuring brake pressure in an anti-lock braking system in an accurate and efficient manner, which enables the braking efficiency associated with the tires to be determined.

### BACKGROUND OF THE INVENTION

A tire is a critical component of a vehicle, as the tire contacts the road and transmits forces that drive the vehicle and stop the vehicle. The ability of the tire to stop the vehicle during braking is a significant factor in the design of any tire. As such, it is desirable to optimize the design of a tire in order to enable the tire to slow and/or stop the vehicle in an effective manner during braking. An indicator of the ability of a particular tire to slow and/or stop the vehicle during braking is the braking efficiency of the tire, which is the ratio between the actual braking performance or vehicle deceleration and the highest possible braking performance as dictated by the maximum grip between the tire and the road. Therefore, during the design and/or development of a tire, it is desirable to determine the braking efficiency of the tire.

In order to determine the braking efficiency of a tire, the pressure of each brake on the vehicle must be obtained as the vehicle executes braking maneuvers while equipped with the tires. In vehicles that include anti-lock braking systems (ABS), the value that is needed is the ABS brake pressure, which enables the determination of ABS braking efficiency. ABS may include brake systems that employ disc brakes or drum brakes, as well as brake systems that are hydraulically actuated or pneumatically actuated. Reference herein shall be made to a hydraulically-actuated disc brake ABS by way of example, with the understanding that the invention also applies to ABS that include drum brakes and pneumatical actuation.

For example, when tires are developed for a consumer vehicle such as a car, the vehicle typically is equipped with four tires that are each mounted on a respective wheel. The ABS is a central system that is actuated by the vehicle brake pedal, and includes hydraulic lines or hoses which transmit hydraulic pressure to a caliper or unit at each wheel. The vehicle executes braking maneuvers and the pressure of each ABS brake unit must be obtained. The respective ABS brake pressure values are used to determine the ABS braking efficiency, which provides an indication of the effectiveness of each tire during braking.

Therefore, obtaining an accurate and real-time value of the ABS brake pressure for each respective brake unit is important. In the prior art, sensors have been employed that are in fluid communication with the hydraulic brake circuit of each ABS unit. Such sensors measure the ABS brake pressure and generate a signal corresponding to the brake pressure, which is then used to determine the ABS braking efficiency.

However, installing such prior art pressure sensors requires opening the hydraulic brake circuit, installing each pressure sensor and bleeding the system. Such installation is time consuming and costly and undesirably involves disturbing the hydraulic circuit. In addition, prior art sensors require installation near the ABS unit brake caliper, which is in a confined space adjacent the wheel. The confined space limits wheel sizes that can be used in association with the sensor, and may lead to sensor damage due to potential contact with the wheel.

As a result, it is desirable to develop an economical, easy-to-install sensor that is not disposed adjacent the wheel and which provides an accurate signal corresponding to the ABS brake pressure to enable the ABS braking efficiency associated with the tires to be determined.

### SUMMARY OF THE INVENTION

According to an aspect of an exemplary embodiment of the invention, a brake pressure sensor is provided. The brake pressure sensor includes a body, which in turn includes a first half and a second half. The first half of the body includes an inner surface and an outer surface, and a semi-circular recess is being formed on the first half inner surface. The second half of the body includes an inner surface and an outer surface, and a semi-circular recess is formed on the second half inner surface. A circular opening is formed by alignment of the recess of the first half of the body with the recess of the second half of the body. The body engages an exterior of a hose of a brake unit of an anti-lock braking system by receiving the hose in the circular opening and a strain gauge is attached to the outer surface of the first half of the body. As the anti-lock braking system is actuated and a pressure inside the hose increases, a diameter of the hose increases, creating increased strain in the body that is measured by the strain gauge.

According to an aspect of another exemplary embodiment of the invention, a brake pressure sensor for determination of braking efficiency is provided. The brake pressure sensor includes a body, which in turn includes a first half and a second half. The first half of the body includes an inner surface and an outer surface, and a semi-circular recess is being formed on the first half inner surface. The second half of the body includes an inner surface and an outer surface, and a semi-circular recess is formed on the second half inner surface. A circular opening is formed by alignment of the recess of the first half of the body with the recess of the second half of the body. The body engages an exterior of a hose of a brake unit of an anti-lock braking system by receiving the hose in the circular opening and a strain gauge is attached to the outer surface of the first half of the body. As the anti-lock braking system is actuated and a pressure inside the hose increases, a diameter of the hose increases, creating increased strain in the body that is measured by the strain gauge. Data from the strain gauge is input into an ABS braking efficiency calculation.

### BRIEF DESCRIPTION OF DRAWINGS

The invention will be described by way of example and with reference to the accompanying drawings, in which:

FIG. 1 is a perspective view of a portion of an ABS unit disposed on a wheel of a vehicle and equipped with a prior art brake pressure sensor and an exemplary embodiment of the brake pressure sensor of the present invention;

FIG. 2 is a perspective view of a prior art brake pressure sensor;

FIG. 3 is an enlarged perspective view of the exemplary embodiment of the brake pressure sensor of the present invention installed on a hose of an ABS unit.

FIG. 4 is a perspective view of the brake pressure sensor shown in FIG. 3 without encapsulation and without installation on the hose of the ABS unit;

FIG. 5 is a perspective view of the brake pressure sensor shown in FIG. 3 without installation on the hose of the ABS unit;

FIG. 6 is a front elevational view, shown partially in cross-section, of a portion of an exemplary embodiment of the brake pressure sensor of the present invention;

FIG. 7 is a side elevational view of the brake pressure sensor shown in FIG. 6;

FIG. 8 is a schematic representation of the signal acquired by the exemplary embodiment of the brake pressure sensor of the present invention and determination of ABS braking efficiency associated with the tires of the vehicle;

FIG. 9 is a graphical representation of a signal of an exemplary embodiment of the brake pressure sensor of the present invention compared to a direct measurement of hydraulic pressure of an ABS unit; and

FIG. 10 is graphical representation of signal linearity of an exemplary embodiment of the brake pressure sensor of the present invention.

Similar numerals refer to similar parts throughout the drawings.

### DETAILED DESCRIPTION OF THE INVENTION

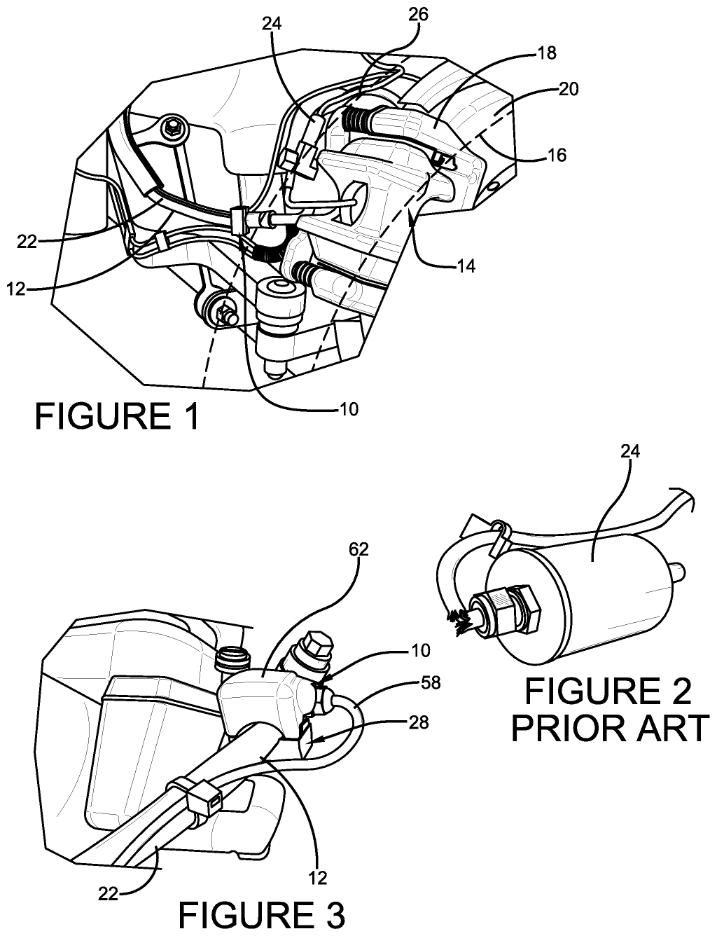

A first exemplary embodiment of the brake pressure sensor of the present invention and the environment in which it operates is shown in FIG. 1. The brake pressure sensor is indicated generally at 10. The sensor 10 is disposed on a hose 12 of an anti-lock braking system (ABS) 14. The ABS 14 is a central system that is actuated by the vehicle brake pedal (not shown) and includes hydraulic lines or hoses, such as the hose 12, which transmit hydraulic pressure to a caliper or brake unit 18 at each specific wheel 16. As mentioned above, ABS may include brake systems that employ disc brakes or drum brakes, as well as brake systems that are hydraulically actuated or pneumatically actuated. Reference herein shall be made to a hydraulically-actuated disc brake ABS 14 by way of example, with the understanding that the invention also applies to ABS that include drum brakes and pneumatical actuation.

As a hydraulically-actuated disc brake ABS 14, a unit 18 which applies force to stop rotation of the wheel 16 is a caliper that acts upon a disc 20, which is connected to the wheel. As is known to those skilled in the art, upon actuation of the vehicle brake, the caliper 18 acts upon the disc 20 to slow and stop rotation of the disc, which in turn slows and stops rotation of the wheel 16 and the tire that is mounted on the wheel. The hose 12 of the ABS 14 contains hydraulic fluid for actuation of the caliper 18. The pressure of the hydraulic fluid in the hose 12 may be referred to as the ABS brake pressure 22.

A prior art brake pressure sensor is shown by way of reference in FIGS. 1 and 2 and is indicated at 24. The prior art sensor 24 must be in fluid communication with the hydraulic system of the ABS 14, and more specifically, a hose 26 at the caliper 18. To install the prior art sensor 24, the hose 26 must undesirably be disconnected from the caliper 18. Once the prior art sensor 24 has been installed, the hose 26 must be reconnected and the hydraulic pressure of the ABS 14 bled. In addition, the prior art sensor 24 must be installed near the caliper 18, which is in a confined space near the wheel 16. Such a confined space limits the sizes of the wheels 16 that may be used with the prior art sensor 24 and exposes the sensor to potential damage from the wheel, as shown in FIG. 2.

As illustrated in FIG. 1, the sensor 10 of the invention is disposed on the hose 22 a distance away from the caliper 18 and the wheel 16. In addition, the sensor 10 is mounted on the exterior of the hose 22, which enables simple and easy installation. It is to be understood that a sensor 10 is disposed on the outer surface of a respective hose 12 for each specific wheel 16 so that there is one sensor for each braking unit or caliper 18. Reference shall be made herein to one sensor 10 for the purpose of convenience, with the understanding that there is one sensor for each braking unit or caliper 18 and thus each wheel 16 and tire.

Turning now to FIGS. 3 through 7, the sensor 10 includes a body 28, which in turn includes a first half 30 and a second half 32. The body 28 may be formed of any suitable rigid material that is also light in weight, and preferably is formed of aluminum or stainless steel. The first half 30 of the body 28 includes an inner surface 34 and an outer surface 36, and a semi-circular recess 38 is formed on the inner surface. The second half 32 of the body 28 also includes an inner surface 40 and an outer surface 42, and a semi-circular recess 44 is formed on the inner surface. The inner surface 40 of the body second half 32 faces the inner surface 34 of the body first half 30. In this manner, the recess 38 of the first half 30 of the body 28 aligns with the recess 44 of the second half 32 of the body to form a circular opening 46. The body 28 engages and clamps about the outer surface of the hose 12 by receiving the hose in the circular opening 46.

Aligned openings 48 are formed in the first half 30 and the second half 32 of the body 28, and the openings receive mechanical fasteners 50, such as bolts. The bolts 50 maintain the first half 30 and the second half 32 of the body 28 in alignment and enable the halves to be secured about the exterior of the hose 12. When bolts are employed, the fasteners 50 also include nuts 52. A nut 52 is disposed on each respective bolt 50 to secure the first half 30 and the second half 32 in engagement with the hose 12. The nuts 52 are secured to the bolts 50 at the outer surface 42 of the second half 32 of the body 28.

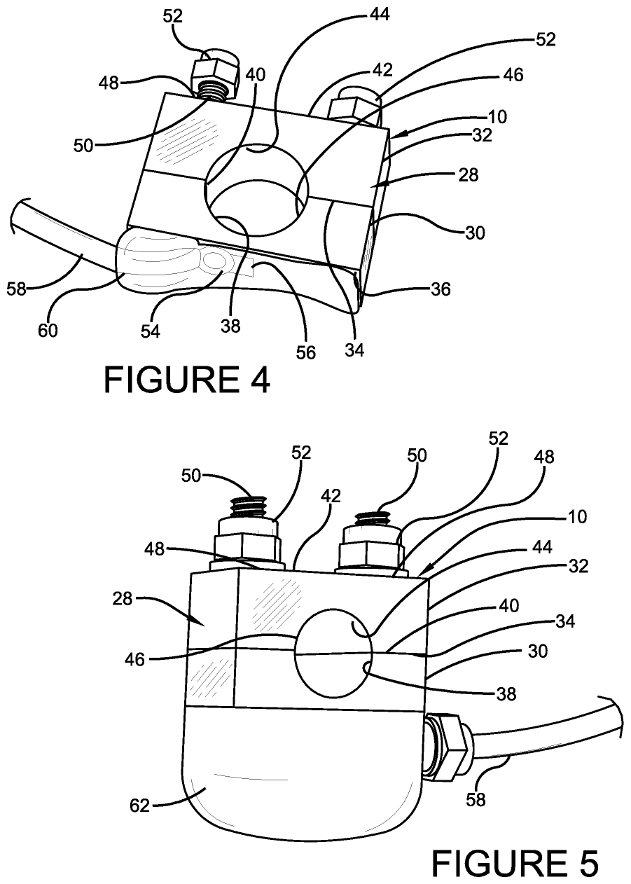

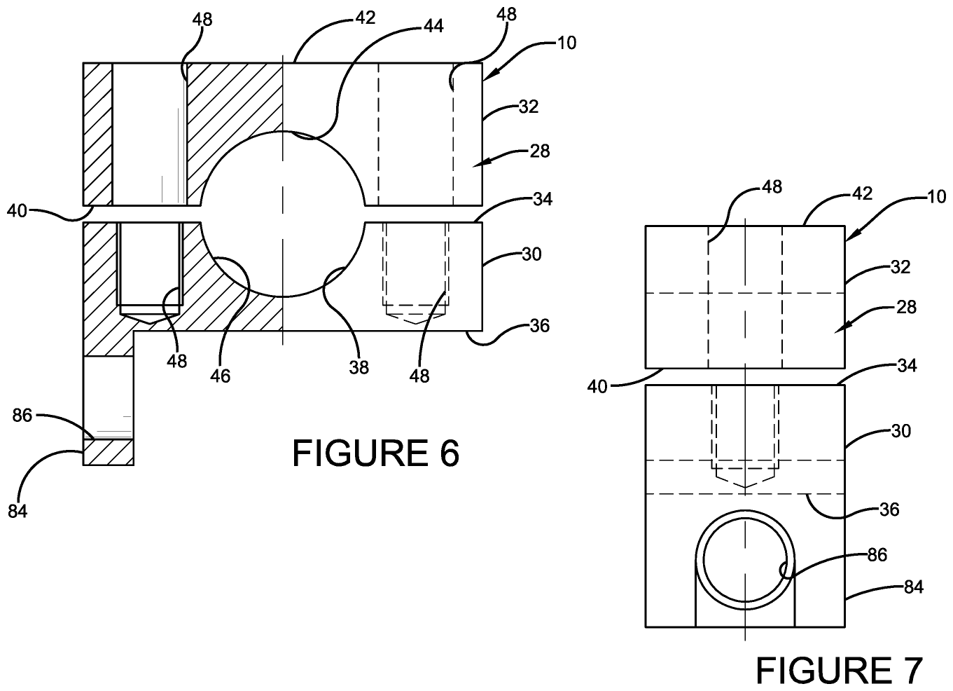

A strain gauge 54 is attached to the outer surface 36 of the first half 30 of the body 28 by an adhesive 56. A wire 58 is electronically connected to the strain gauge 54 at a connection point 60 to transmit the output of the strain gauge, as will be described in greater detail below. The connection point 60 may include an adhesive (FIG. 4) that secures the wire 58 to the strain gauge 54 and the outer surface 36 of the first half of the body 30, and/or a lug 84 with an opening 86 (FIGS. 6 and 7) which enables the wire to be mechanically secured to the strain gauge and the outer surface of the first half of the body. The strain gauge 54 and the connection point 60 preferably are encased in a protective layer or housing 62, such as a silicone compound, to protect the gauge and the electronic connection.

As mentioned above, a respective sensor 10 is disposed on the outer surface of the hose 12 of the braking unit or caliper 18 for each specific wheel 16 and thus each tire. The circular opening 46 enables the first half 30 and the second half 32 of the body 28 to securely clamp around the circumference of the surface of the hose 12, and each half of the body remains in secure engagement with the hose through the use of the fasteners 50. As the ABS 14 is actuated, the hydraulic pressure inside the hose 12 increases. When the hydraulic pressure inside the hose 12 increases, the hose expands, causing the diameter of the hose to increase. Because the sensor 10 is rigidly clamped about the hose 12 and is fixed with the fasteners 50, the expansion of the hose creates increased strain in the body 28. Such increased strain is measured by the strain gauge 54 that is affixed to the outer surface 36 of the first half 30 of the body 28.

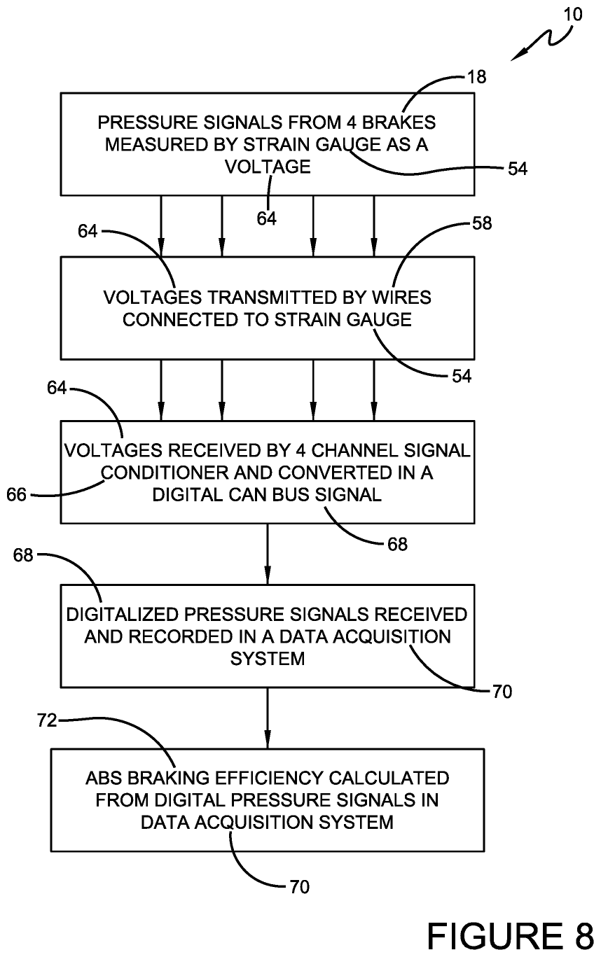

The strain on the sensor 10 is proportional to the pressure inside the hose 12, so that the strain indicated by the strain gauge 54 is proportional to the ABS brake pressure 22 (FIG. 1). With additional reference now to FIG. 8, to enable processing of the measurement of the strain gauge 54, the measurement is converted to a voltage 64 by the strain gauge. The wire 58 that is electronically connected to the strain gauge 54 transmits the measured voltage 64 to a signal conditioner 66, such as a four-channel signal conditioner. The measured voltage 64 is then converted into a digital controlled area network (CAN) bus signal or digital pressure signal 68 by the signal conditioner 66. The digital pressure signals 68 are received and recorded in a data acquisition system 70.

In this manner, real-time measured strain values that correspond to the ABS brake pressure 22 for each brake unit or caliper 18 are converted to a voltage 64 and converted into digital pressure signals 68, which are then logged and stored by the data acquisition system 70. The data acquisition system 70 may include a global positioning system (GPS) data logger, and may also record and/or store other parameters relating to the vehicle and/or wheels 16, including vehicle speed, vehicle position, vehicle acceleration, wheel acceleration, individual wheel speeds, and the like.

The digital pressure signal data 68 is then used to determine the ABS braking efficiency 72. More particularly, the digital pressure signal data 68 is input from the data acquisition system 70 into a known ABS braking efficiency calculation. For example, many ABS brake efficiency calculations include dividing the total brake effort by the best effort of the vehicle driver, or the best theoretical braking effort, and multiplying the result by 100 to express the efficiency as a percentage. The digital pressure signal data 68 is indicative of or corresponds to the ABS brake effort in such a calculation.

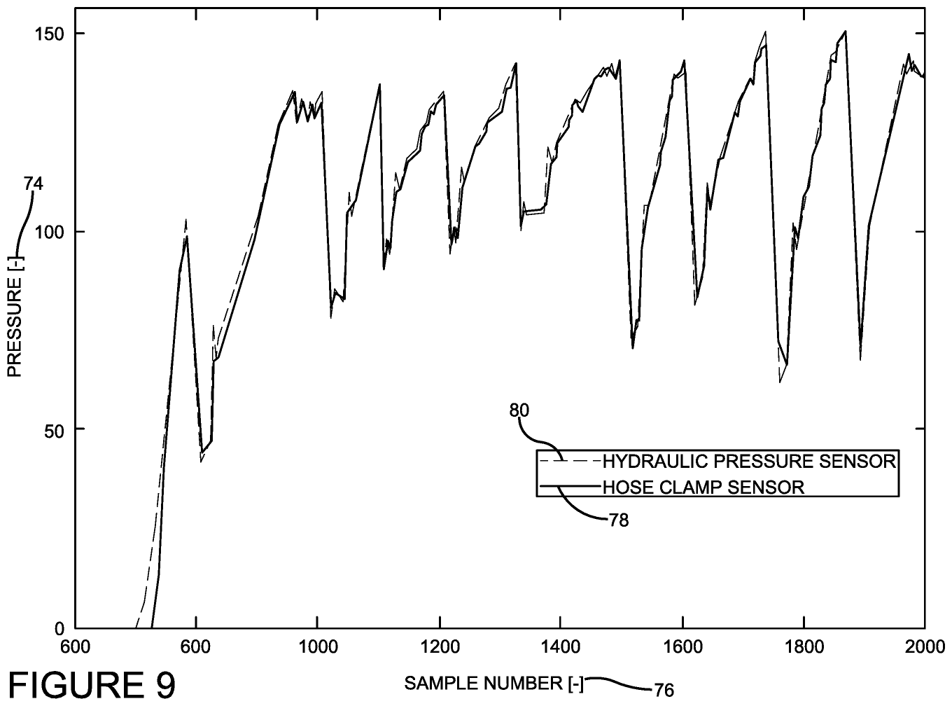

Referring now to FIG. 9, the pressure sensor 10 was tested for accuracy. The ABS unit pressure, indicated at 74, was plotted or graphed over time 76. A pressure profile 78 generated by the pressure sensor 10 was compared to a direct measurement of the ABS pressure 80. The graph in FIG. 9 shows that the ABS brake pressure profile 78 generated by the sensor 10 is accurate. In addition, the accuracy of the profile 78 generated by the sensor 10 may be further improved by adjusting the gain and offset of the signal, and/or by adjusting the temperature compensation of the strain gauge 54 to match the material of the body 28.

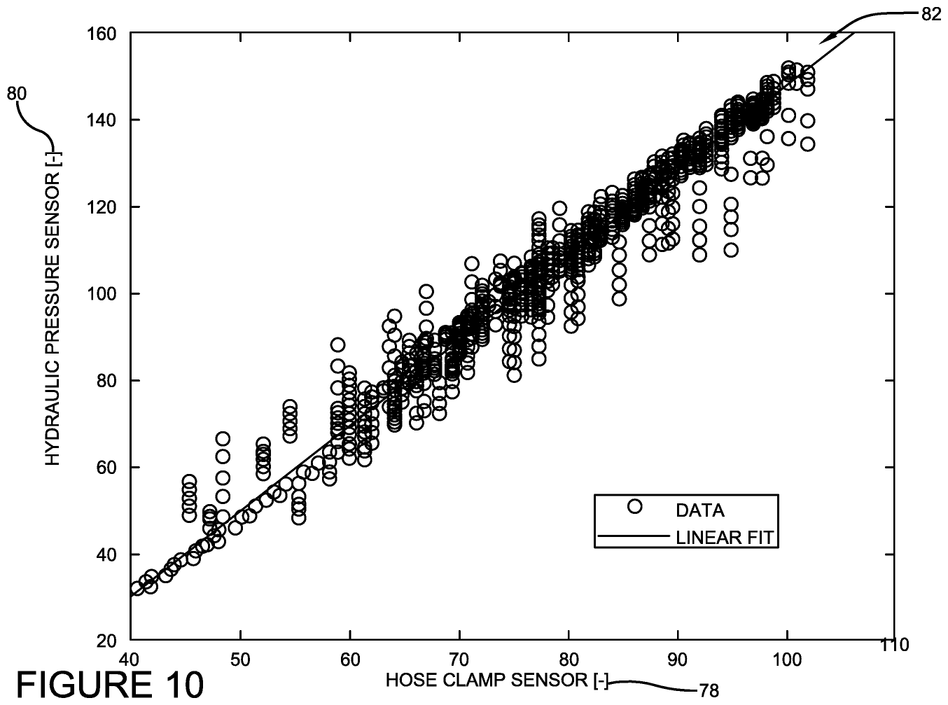

Turning to FIG. 10, the signal linearity 82 of the pressure sensor 10 has been plotted. For the determination of ABS braking efficiency 72, the offset and linearity of the digital pressure signal 68 is important, while the absolute level, or gain, of the signal is not as important. The offset may be adjusted by evaluating the digital pressure signal 68 when the vehicle brake pedal is not actuated. In addition, the linearity versus hydraulic pressure signal is accurate, except for the first brake pressure ramp-up, which may be excluded from the ABS braking efficiency determination 72.

The sensor 10 of the invention thus includes simple, commonly available components, which can be configured as needed to match a target vehicle at a low cost and in a short amount of time. In addition, by being installed around the brake hose 12, the sensor 10 does not require the hydraulic circuit of the ABS 14 to be opened or disturbed. Moreover, because the sensor 10 is installed on the brake hose 12, instead of at or near the brake unit or caliper 18, the sensor does not limit the wheel sizes used and is not susceptible to damage due to contact with the wheel 16.

In this manner, the invention provides an economical, easy-to-install sensor 10 that is not disposed adjacent the wheel 16, and which provides an accurate signal 68 corresponding to the ABS brake pressure 22 to enable the ABS braking efficiency 72 associated with the tires to be determined.

The present invention also includes a method of measuring brake pressure to enable the determination of ABS braking efficiency for a tire. The method includes steps in accordance with the description that is presented above and shown in FIGS. 1 and 3 through 10.

It is to be understood that the structure of the above-described sensor 10 and associated determination of ABS braking efficiency may be altered or rearranged, or components or steps known to those skilled in the art omitted or added, without affecting the overall concept or operation of the invention. The invention may be employed in any ABS, including brake systems that employ disc brakes or drum brakes, as well as brake systems that are hydraulically actuated or pneumatically actuated. In addition, the principles of the invention find application in any vehicle category, such as passenger vehicles, commercial vehicles, off-the-road vehicles and the like.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A brake pressure sensor comprising:
a body, the body including a first half and a second half;
the first half of the body including an inner surface and an outer surface, and a semi-circular recess being formed on the first half inner surface;
the second half of the body including an inner surface and an outer surface, and a semi-circular recess being formed on the second half inner surface;
a circular opening formed by alignment of the recess of the first half of the body with the recess of the second half of the body;
the body engaging an exterior of a hose of a brake unit of an anti-lock braking system by receiving the hose in the circular opening; and
a strain gauge being attached to the outer surface of the first half of the body, whereby as the anti-lock braking system is actuated and a pressure inside the hose increases, a diameter of the hose increases, creating increased strain in the body that is measured by the strain gauge.

2. The brake pressure sensor of claim 1, further comprising a plurality of brake pressure sensors, wherein each sensor engages a hose of a respective braking unit of the anti-lock braking system.

3. The brake pressure sensor of claim 1, wherein the first half and the second half of the body are formed with aligned openings for receiving mechanical fasteners.

4. The brake pressure sensor of claim 3, wherein the mechanical fasteners include bolts and nuts.

5. The brake pressure sensor of claim 4, wherein each nut is secured to a respective bolt at the outer surface of the second half of the body.

6. The brake pressure sensor of claim 1, wherein the strain gauge is attached to the outer surface of the first half of the body by an adhesive.

7. The brake pressure sensor of claim 1, wherein the strain gauge is encased in a protective layer.

8. The brake pressure sensor of claim 7, wherein the protective layer includes silicone.

9. The brake pressure sensor of claim 1, wherein the measurement of the strain gauge is converted to a voltage.

10. The brake pressure sensor of claim 9, further comprising a wire electronically connected to the strain gauge, the wire transmitting the voltage to a signal conditioner.

11. The brake pressure sensor of claim 10, wherein a digital pressure signal from the signal conditioner is recorded by a data acquisition system.

12. The brake pressure sensor of claim 11, wherein the digital pressure signal is input into an ABS braking efficiency calculation.

13. The brake pressure sensor of claim 12, wherein the data acquisition system records at least one of vehicle speed, vehicle position, vehicle acceleration, wheel acceleration and individual wheel speeds.

14. A brake pressure sensor for determination of braking efficiency comprising:
a body, the body including a first half and a second half;
the first half of the body including an inner surface and an outer surface, and a semi-circular recess being formed on the first half inner surface;
the second half of the body including an inner surface and an outer surface, and a semi-circular recess being formed on the second half inner surface;
a circular opening formed by alignment of the recess of the first half of the body with the recess of the second half of the body;
the body engaging an exterior of a hose of a brake unit of an anti-lock braking system by receiving the hose in the circular opening; and
a strain gauge being attached to the outer surface of the first half of the body, whereby as the anti-lock braking system is actuated and a pressure inside the hose increases, a diameter of the hose increases, creating increased strain in the body that is measured by the strain gauge, wherein data from the strain gauge is input into an ABS braking efficiency calculation.

15. The brake pressure sensor for determination of braking efficiency of claim 14, wherein the measurement of the strain gauge is converted to a voltage.

16. The brake pressure sensor for determination of braking efficiency of claim 15, wherein the voltage is amplified by a signal conditioner.

17. The brake pressure sensor for determination of braking efficiency of claim 16, wherein the digital pressure signal from the signal conditioner is recorded by a data acquisition system.
